(19) United States
(12) Patent Application Publication
(10) Pub. No.: US 2010/0224796 A1
(43) Pub. Date: Sep. 9, 2010

(54) Imaging System Using Dynamic Speckle Illumination

(76) Inventors: Jerome Mertz, Boston, MA (US); Catherine Ventalon, Paris (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/991,772

(22) PCT Filed: Sep. 8, 2006
(86) PCT No.: PCT/US06/35111

§ 371 Date: Mar. 10, 2008

Related U.S. Application Data
(60) Provisional application No. 60/740,498, filed on Nov. 29, 2005.
(60) Provisional application No. 60/715,953, filed on Sep. 9, 2005.

(51) Int. Cl. G01N 21/64; G01J 1/58

(52) U.S. Cl. 250/459.1; 250/458.1; 250/226; 250/216

(57) ABSTRACT

A versatile, imaging system that uses dynamic speckle illumination (DSI) is disclosed. The DSI microscope includes at least one light source for producing light to illuminate a target object in an object plane; an image recording device for recording a sequence of images of the target object; imaging optics for transmitting signal light from the target object as the sequence of images from the target object to the image recording device; and a dynamic speckle generating system for illuminating the target object with dynamic speckle.

### CROSS REFERENCE TO RELATED APPLICATIONS

This application claims the benefit of U.S. provisional patent application No. 60/740,498 filed on Nov. 29, 2005 and U.S. provisional patent application No. 60/715,953 filed on Sep. 9, 2005, which are incorporated herein in their entirety by reference.

### STATEMENT REGARDING FEDERALLY SPONSORED RESEARCH OR DEVELOPMENT

N/A

### BACKGROUND OF THE INVENTION

The present invention discloses a system and a method of imaging and, more particularly, a system and method of fluorescence imaging using dynamic speckle illumination that suppresses out-of-focus background.

By definition, optical, depth sectioning implies an ability to determine the axial position of a thin uniform plane. It is well known to those skilled in the relevant art that standard wide-field fluorescence microscopy cannot provide optical, depth sectioning. Indeed, with wide-field microscopy, a uniform fluorescent plane produces the same image independently of its axial position.

Confocal fluorescence microscopy is a well-established technique in the biosciences community and an alternative to wide-field microscopy. Confocal fluorescence microscopy entails focusing and scanning diffraction-limited spot of light sequentially across selected points or areas of a target object to be imaged, such as mammalian tissue, and optically detecting, i.e., re-focusing, the light emerging (usually fluorescence) from the selected points or areas through a pinhole, to construct a three-dimensional image of the object.

In contrast with wide-field microscopy, one advantage confocal microscopy provides is that it allows depth discrimination inside the sample. More specifically, confocal microscopy provides an axial sectioning capability. The apparent intensity of a uniform plane scales as 1/Δz², where Δz is the displacement of the plane from the focal or object plane.

It is often desirable to remove the “haze” normally associated with fluorescence imaging in thick samples, which, commonly, arises from the inability of a standard, wide-field microscope to reject out-of-focus background. Several techniques exist for out-of-focus background rejection. Typically, they involve scanning approaches or non-scanning approaches. However, standard implementation of confocal microscopy involves scanning over one or multiple points, which in general leads to an elaborated technique.

An alternative scanning technique is a two-photon microscope, which obviates the need for signal re-focusing through a pinhole, but requires the use of pulsed laser illumination. Both confocal microscopy and two-photon microscopy, in their usual implementations, are quite expensive and involve the acquisition of three-dimensional images one pixel at a time with the use of a laser scanning mechanism. Moreover, both techniques usually work only in the high-resolution regime, typically at the micron level. Inasmuch as there is a tradeoff between penetration depth and resolution when imaging in scattering media, high resolution necessarily implies shallow depth. Indeed, both confocal and two-photon microscopes rarely provide imaging below a few hundred microns in scattering tissue.

Yet another technique for depth-sectioning is based on deconvolution. The idea of deconvolution is to remove blur by wide-field image post-processing. This technique requires precise, usually a priori, knowledge of the blurring characteristics of the imaging optics to correct for blurring. In general, the correction algorithms needed are complicated and prone to artifact when imaging in thick tissue. Moreover, depth-sectioning of an object plane of interest requires acquisition of images from several reference planes above and from several reference planes below the object plane, and, hence, requires calibrated axial translation.

Non-scanning alternatives to suppress out-of-focus background use an incoherent, structured light pattern, such as a one-dimensional grid, to illuminate the area of interest of a target object. An example is structured light illumination (SLI) microscopy, which confers wide-field optical (depth) sectioning. This elegant technique was developed in 1997 by the Wilson group at Oxford University and is now being marketed by, amongst others, Zeiss Microscopy of Germany under the name of “ApoTome”. The principle of SLI microscopy is as follows.

Instead of performing wide-field illumination with a uniform distribution of light, one performs illumination with a “structured” distribution light using a finely-spaced grid pattern. The resulting structured signal from the object is imaged onto a camera, producing an image I₁. The grid is then laterally displaced twice, each time by a third of the grid period, producing shifted images I₂ and I₃.

A simple algorithm is applied to obtain the final SLI microscope image:

$$SLI = \sqrt{\frac{1}{3} \{ {( {I}_{1} - {I}_{2} )}^{2} + {( {I}_{2} - {I}_{3} )}^{2} + {( {I}_{1} - {I}_{3} )}^{2} \}}$$

According to Wilson, et al. this algorithm preferentially rejects out-of-focus background while preserving in-focus signal. Hence, this algorithm purportedly confers depth sectioning similar to that obtained with a confocal microscope. A significant advantage of SLI microscopy is that it does not require scanning (except for the slight lateral shifts in the grid pattern). A disadvantage is that, unlike confocal microscopy where the out-of-focus background is physically blocked from the detector by a pinhole, SLI microscopy only “virtually” blocks the background through post-imaging processing. Thus, if the background is too large, detector saturation and/or photon noise, i.e., shot-noise, can overwhelm the in-focus signal.

Conventionally, SLI microscopy is based on incoherent illumination, i.e., illumination is composed of many different wavelengths completely uncorrelated in phase. Typical incoherent light sources are arc-lamps or light bulbs. In the original SLI implementation, the light source was an ordinary halogen lamp. In a subsequent implementation, the light source was a coherent laser. However, a rapidly rotating diffuser plate was included to render the laser beam effectively incoherent.

Another shortcoming of the SLI technique includes the SLI algorithm given above, which can be re-expressed as:

$$SLI ∝ \sqrt{\frac{1}{N} {\sum }_{ }^{ } {( {I}_{i} - \overline{I} )}^{2}}$$

where the summation is done over the N=3 images, and I-bar is the image average. In short, the SLI microscopy algorithm simply produces the root-mean-square (RMS) of the image sequence.

U.S. Pat. No. 6,687,052 to Wilson, et al. discloses a confocal microscope that purportedly enables real-time imaging. The Wilson confocal microscopy device includes two matched, structured light sources that are arranged to illuminate opposite sides of a modulating mask. More specifically, one of the light sources is disposed on the same side of the mask as the object. The other light source is disposed on the side of the mask opposite the object. Light from both light sources is reflected or refracted off of the modulating mask to illuminate the object. The reflected image of the object produced by the light source on the same side of the mask as the object is subtracted from the reflected image of the object produced by the light source on the side of the mask opposite the object to construct a two-dimensional, confocal image.

It is desirable to provide a system and method of providing depth discrimination and out-of-focus blur reduction in relatively-thick tissues without having to use more complicated, scanning mechanisms.

### BRIEF SUMMARY OF THE INVENTION

The present invention provides a fluorescence imaging alternative that provides out-of-focus background rejection but is much simpler to implement than either confocal or SLI microscopy. Microscopy by dynamic speckle illumination (DSI) and a system and method for performing the same are disclosed. More specifically, the present invention provides out-of-focus blur reduction without lateral or axial scanning, without precise optical alignment, and without any need for a priori information about system characteristics.

A versatile, microscope that can provide near-confocal quality imaging using dynamic speckle illumination (DSI) is disclosed. The DSI microscope includes a light source for producing light to illuminate a target object; an image recording device for recording a sequence of fluorescence image signals of the target object; imaging optics for transmitting fluorescence signals from the target object to the image recording device; and a dynamic speckle generating system for illuminating the target object with dynamic speckle.

The disclosed DSI microscope and method of DSI microscopy of the present invention are designed for high-resolution imaging. Variable resolution and, hence, variable depth penetration is also disclosed.

### BRIEF DESCRIPTION OF THE SEVERAL VIEWS OF THE DRAWINGS

The foregoing and other objects, features, and advantages of the invention will be apparent from the following Detailed Description of the Invention in conjunction with the Drawings of which:

FIG. 1 shows a schematic of a dynamic speckle illumination (DSI) microscope in accordance with the present invention;

FIG. 2A shows a profile of incoherent grid illumination by SLI for a relatively thin sample;

FIG. 2B shows a profile of coherent speckle illumination by DSI for a relatively thin sample;

FIG. 3A shows a profile of incoherent grid illumination by SLI for a relatively thick sample;

FIG. 3B shows a profile of coherent speckle illumination by DSI for a relatively thick sample;

FIG. 4 shows a DSI microscope having a liquid crystal spatial light modulator (SLM) for generating dynamic speckle;

FIG. 5A shows a DSI image of a pollen grain based on an RMS algorithm;

FIG. 5B shows a wide-field image of the same pollen grain of FIG. 5A;

FIG. 6 shows DSI and wide-field images of mouse olfactory bulb glomerulus with depth based on an RMS algorithm; and

FIG. 7 shows a DSI microscope having an imaging fiber-optic bundle.

### DETAILED DESCRIPTION OF THE INVENTION

Microscopy by dynamic speckle illumination (DSI) and a system and method for performing the same are disclosed. DSI microscopy includes a modification to a standard wide-field fluorescence microscope. Advantageously, DSI microscopy provides depth discrimination in relatively thick tissues without the use of a complicated scanning mechanism.

DSI microscopy is similar to SLI microscopy in some ways. However, in place of an incoherent grid pattern for illumination, DSI microscopy illuminates target objects using a coherent speckle pattern. The consequences of this seemingly innocuous replacement are quite significant.

Although the phenomenon of speckle is well known, its properties are often poorly understood. Speckle arises from the coherent superposition of light rays possessing random phases. For example, when a laser beam is reflected off a grainy surface, the variations in the surface relief provoke random phases throughout the beam profile, which in turn impart an apparent granularity on the beam when observed by the eye or other imaging device. This granularity is referred to as “speckle”.

If the laser beam is polarized and has a well-defined wavelength, i.e., is “coherent”, the speckle contrast is unity. That is, speckle spots of high intensity are separated by regions of complete darkness. These regions of complete darkness are caused by random cancellations in the light ray phases that are, quite remarkably, perfect.

Thus, to exhibit highly-contrasted speckle, the illuminating light should be of a single (narrowband) wavelength. For example, if two beams of different wavelengths exhibiting different speckle patterns are superposed, then their speckle patterns are also superposed, leading to a reduced granularity contrast. Moreover, if several beams of different wavelengths are superposed, as in the case of incoherent, wideband light, then the several superposed speckle patterns blend perfectly; the light appears uniform; and the contrast of the granularity becomes completely washed out. For this reason, a lamp cannot produce speckle whereas a laser can.

If the sample is relatively thick, then speckle granularity occurs in three dimensions. That is, illumination comprises a fine hail of randomly distributed grains of light. The size of these grains depends on the illumination conditions, such as objective lens power and so forth.

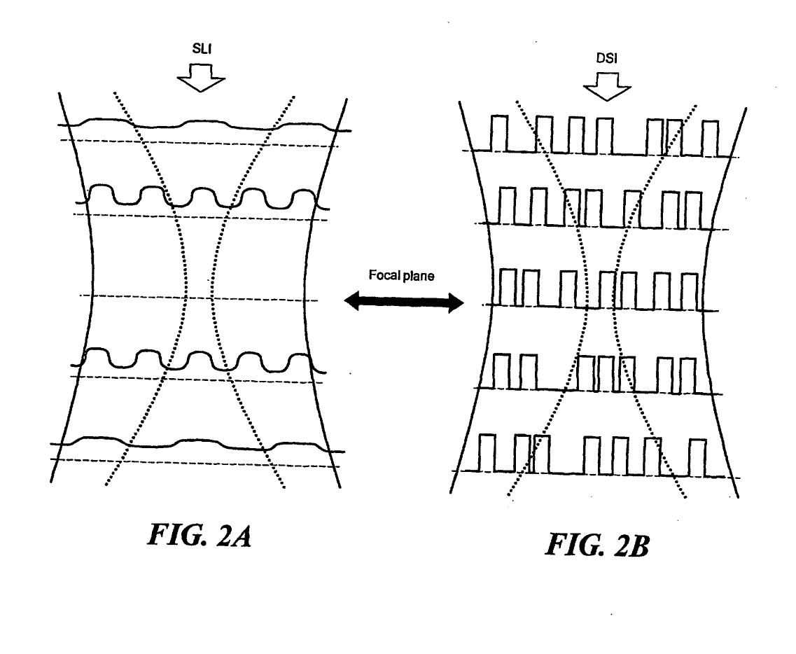

A comparison of the illumination profile produced by coherent speckle with one produced by an incoherent grid pattern, such as used in SLI, is shown in FIGS. 2A and 2B. With FIG. 2A, because the SLI grid pattern is incoherent, its various wavelength components arrive in phase only at a well defined axial plane, called here the “focal” or the “object” plane. The contrast of the grid pattern is high, or at a maximum, only at this plane. Above and below this plane, the contrast becomes blurred. This is very different from the case of coherent speckle illumination (FIG. 2B) in which the speckle grains maintain their small size and high contrast throughout an extended depth.

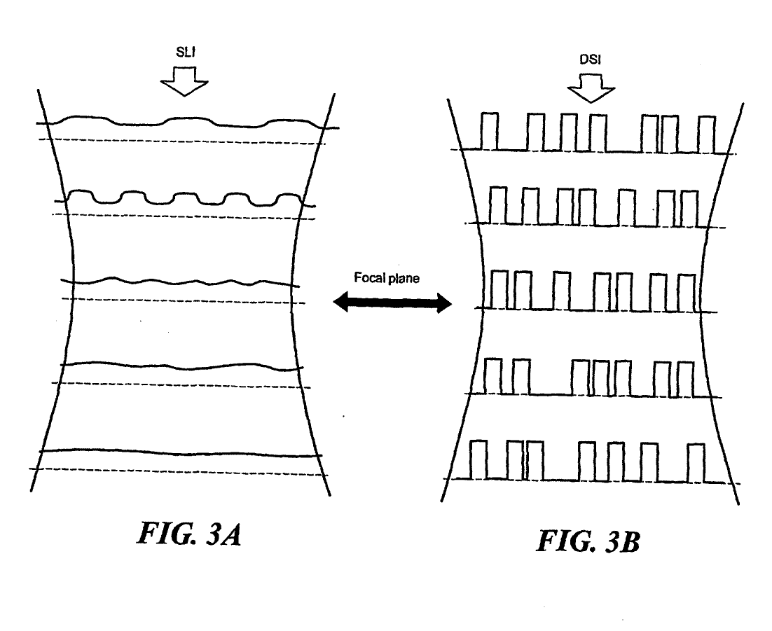

A comparison of the illumination profile produced by coherent speckle in thicker samples with a profile produced by an incoherent grid pattern is shown in FIGS. 3A and 3B. For FIG. 3B corresponding to the illumination profile for coherent speckle illumination, the various wavelength components arrive in phase only at the well-defined object plane. The contrast is high, or at a maximum, only at this plane. Above and below the object plane, for the coherent speckle illumination, the contrast becomes blurred. The same is true on all planes including the focal plane for an incoherent grid pattern.

When using an image recording device, such as a CCD camera, to detect and image the fluorescence produced by these illumination patterns, because fluorescence is incoherent, on its way to the CCD camera, fluorescence will experience a similar blurring phenomenon that the incoherent grid pattern experienced on the way to the target object. That is, the fluorescence signal will maintain a high contrast and appear in focus only if it arises from the object plane. Herein lies a fundamental difference between fluorescence imaging using a grid pattern and fluorescence imaging using dynamic speckle: out-of-focus blurring occurs twice when using a grid pattern, i.e., upon illumination and upon detection, whereas blurring occurs only upon detection using dynamic speckle illumination.

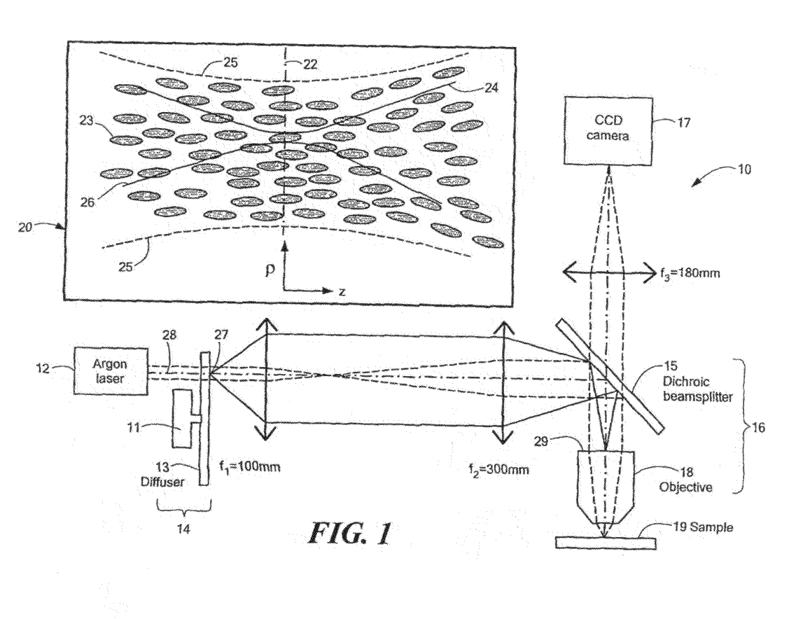

Referring to FIG. 1, a DSI microscope 10 in accordance with the present invention will be described. The DSI microscope 10 includes a high-intensity light source 12, imaging optics 16, an image recording device or imaging device 17, and a system or mechanism to generate dynamic speckle 14.

The high-intensity light source 12 can be a laser, such as an argon gas laser (λ=488 nm) with an average power of about 40 mW. An argon gas laser is ideal for imaging Green Fluorescent Protein (GFP), which has a blue-green excitation peak at about 490 nm and a green emission peak at about 510 nm. Suitable argon gas lasers are manufactured by JDS Uniphase of Milipitas, Calif.

With an argon gas laser, both illumination and fluorescence when imaging GFP are in the relatively-short wavelength end of the visible spectrum. Disadvantageously, the shorter the wavelength, the more susceptible the light is to scattering due to the medium.

Scattering does not pose a problem during the illumination stage of DSI molecular imaging because it does not change the inherent, high-contrast granular nature of speckle. However, scattering can pose a problem during the detection stage of DSI fluorescence imaging because scattering leads to blurring of the in-focus fluorescence signal of interest. Furthermore, lower wavelengths tend to be more absorbed by biological tissue. For example, hemoglobin in blood possesses a very high absorption coefficient for wavelengths green or shorter.

Thus, more advantageous operating wavelengths could be in the near-infrared (NIR) region, roughly defined as the wavelength range between 700 nm and 1 μm. Wavelengths above 1 μm are no longer advantageous because the increased absorption provoked by water can lead to sample heating problems.

The advantages and benefits of working with NIR light are well known to those skilled in the art. Indeed, the NIR wavelength range is often referred to as a “therapeutic window”. Therefore, to enhance depth penetration further and to reduce potential problems with tissue auto-fluorescence, bright, NIR laser sources can be used as light sources instead of or in conjunction with argon gas lasers.

Use of longer wavelength illumination and brighter probes can attain deeper imaging depths (on the order of 1 cm in small-animal models). Phenomenologically, it has been observed that the scattering coefficient(s) in tissue scale(s) roughly inversely with wavelength in the visible to NIR spectrum range. As was suggested above, speckle illumination is largely unaffected by scattering, this suggestion is only partially true. Particularly, scattering provokes a widening of the field-of-illumination D, which, in turn, provokes an undesired reduction in the power density, or intensity, at the focal plane. Inasmuch as a limitation in laser power is a main reason for long image acquisition times, maintenance of power density (intensity) is important for deep imaging.

Moreover, although it is not necessary to image the speckle excitation into the target object 19, it is certainly necessary to image the fluorescence emission onto the CCD camera 17. Scattering in the tissue, however, provokes blurring of the fluorescence signals on their way to the camera 17. This blurring can be characterized in a variety of manners. However, reducing scattering leads to reduced blurring. By adopting longer illumination wavelengths associated with an NIR probe, commensurately longer fluorescence wavelengths are obtained, which reduces fluorescence scattering.

Upgrading to NIR illumination also reduces the possibility of tissue autofluorescence, which is known to virtually disappear with NIR illumination. Tissue autofluorescence often leads to unacceptable background that can overwhelm a signal of interest.

Preferably, the NIR probes deliver reasonably high power, e.g., greater than about 100 mW, and emit a beam that is longitudinally single-mode, i.e., longitudinally coherent.

Implementation of NIR illumination can also make use of several new long-wavelength probes, such as quantum dots (QD's), and a variety of new (non-genetic) molecular markers. Commercially-available QD's operating in the lower visible to upper NIR wavelength range are well-suited for use with the DSI microscope 10. Some remarkable features of QD's are their improved brightness (sometimes by orders of magnitude) and their immunity to photo-bleaching relative to molecular markers. Another advantageous feature of QD's is their very narrow emission linewidths, which allows the possibility of multicolor labeling using a single illumination source with very little crosstalk between colors.

In anticipation of the large variety of probes already available for in-vivo molecular and fluorescence imaging, the DSI molecular microscope 10 according to the present invention can also be structured and arranged to support multicolor imaging, which is to say, imaging from multiple excitation sources having different wavelengths. Multicolor imaging can be performed using a single camera 17 and an appropriate set of emission filters (not shown). Alternatively, multicolor imaging can be performed using multiple cameras 17 and dichroics 15. The latter alternative is more expensive but provides simultaneous and, therefore, faster imaging.

Examples of dual-color labeling can involve two QD's of different colors, which are both excitable by a single laser source. Alternatively, by combining, for example, argon gas and NIR excitation, GFP and NIR molecular markers can be imaged simultaneously. When used in conjunction with an argon gas laser, the additional NIR laser source will allow simultaneous dual-color imaging, thereby enhancing the versatility of the microscope 10.

New genetic markers having longer wavelengths are also being developed. Thus, derivatives of GFP and mRFP1 have already extended the spectral palette of genetic markers into the deep red. In particular, a protein known as mPlum is bright, photostable, and possesses excitation and emission wavelengths of about 590 nm and about 650 nm, respectively. Consequently, the development of genetic markers that can be excited by a simple helium-neon (HeNe) laser (λ=633 nm) are expected and suitable for use in DSI microscopy.

The imaging optics 16 can include a beam-splitter 15, a plurality of beam expansion or focusing lenses f1, f2, and f3, and an objective 18, such as an Olympus PLAN 60X water immersion objective having a focal length f=3 mm and a numerical aperture NA=0.9 manufactured by Olympus of Center Valley, Pa.

Images of the object 19 can be recorded using an imaging device 17, such as a standard, interline CCD-type camera, like the Retiga 2000R CCD camera manufactured by QImaging® of Burnaby, British Columbia, Canada.

One system or mechanism 14 for generating dynamic speckle includes a moving diffuser plate 13 mounted on a stepper motor 11. The stepper motor 11 progressively rotates the diffuser plate 13 one “step” per image, to randomize the speckle pattern and to provide a sequence of images.

Light passing through the moving diffuser plate 13 at each step is, further, transmitted through a beam-splitter 15 to the back aperture 29 of the objective 18, which produces DSI at the target object 19. More specifically, high-intensity light 28 from the light source 12 passes through the moving diffuser plate 13. Beam expansion of focusing lenses f1 and f2 are structured and arranged in the light path so that the laser spot 27 at the diffuser plate 13 is imaged on the objective back aperture 29. Beam expansion or focusing lens f3 is structured and arranged in the light path so that the target object 19 is imaged on the image plane of the imaging device 17.

The inset in FIG. 1. shows a two-dimensional, schematic view of the DSI 20 inside the target object 19. The field of illumination 25, which is demarcated by the dotted lines, has a diameter, D, of about 300 to about 500 μm at the objective focal plane 22. The solid lines 24 and 26 show the detection point spread function (PSF_{det}) corresponding to the target signal “seen” by an arbitrary pixel of the imaging device 17. The small, elongated ellipsoids 23 comprise the speckle pattern.

The size of each speckle grain 23 at an axial distance, z, from the focal plane 22 is roughly equal to:

λ/θ(z),

where λ is the wavelength of the light source 12 and θ(z) is the actual angle of aperture at the axial distance z, i.e., the angle covering all the rays coming from the diffuser 14. For simple geometric considerations, the speckle size is roughly constant over a depth of field |z|<D/NA, where NA is the numerical aperture of the objective 18. The present inventors have found that this depth of field was almost one (1) millimeter and corresponds to the region where the full pupil can be seen (assuming that f>>D). The size of the speckle grains was, typically, about 0.5 μm in lateral dimension and about 0.9 μm in axial dimension.

Rotating a diffuser plate 13 to produce speckle illumination has some shortcomings. First, there is no way to control the substantial beam spread induced by the diffuser plate 13, which can lead to significant power loss through the microscope optics 16. Second, the rotating diffuser plate 13 is a moving part. Moreover, every time the stepper motor 11 is activated and the diffuser plate 13 rotated one step, vibrations propagate through the entire microscope 10 chassis, which requires about 300 ms to dampen. Although system electronics can be adjusted to allow sufficient time for these vibrations to dampen between image acquisitions, the net result is a significant dead time in total acquisition time.

Finally, there is no way to control the speckle grain size easily. Currently, speckle grain sizes are diffraction limited by the full NA of the objective 18. As a result, speckle grains are small.

As an alternative to a moving diffuser plate 13, a liquid-crystal spatial light modulator (SLM) can be used to generate speckle illumination. A “variable resolution” DSI microscope 10 using a liquid-crystal spatial-light modulator can provide high resolution from sub-micron to several tens of microns. Such variable resolution will allow variable depth penetration. Versions of SLM devices are often found in standard video projectors. A research-quality device is available from Boulder Nonlinear Systems of Lafayette, Colo. or Holoeye Photonics AG of Berlin, Germany.

An SLM device can be thought of as an array of computer-controllable, bi-refringent pixels, which allows a pixel-by-pixel adjustment of the local phase and/or polarization of a transmitted illumination front. Addition of a polarizer (not shown) further allows pixel-by-pixel control of the local illumination amplitude. The number of pixels in the SLM device can be substantial, such as on the order of 1000×1000. However, control can easily be performed at a video rate.

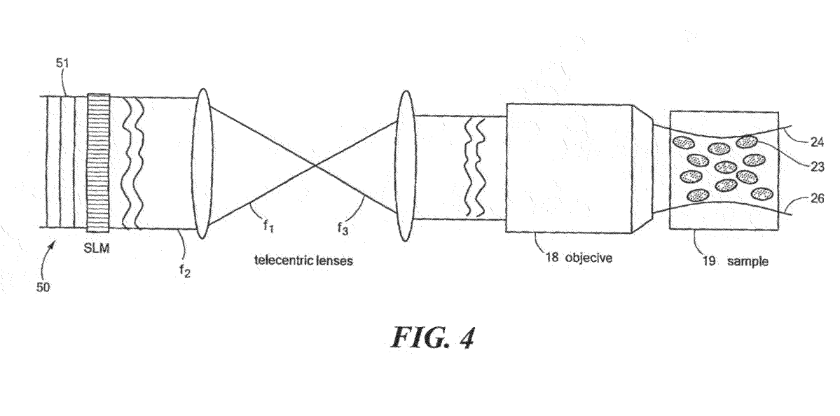

Referring to FIG. 4, there is shown the illumination stage of a DSI microscope 10 having a SLM 50 in lieu of a rotating diffuser plate 13. The light beam 51 is first expanded and then focused through the SLM 50 onto the target object 19. By applying random phase shifts to each pixel in the SLM 50, the effects 52 of a diffuser plate 13 can be re-produced.

The SLM 50 is not a moving part, hence, there are no vibration problems. Furthermore, the effective granularity of these random phase shifts can be controlled. For example, one can bin the pixels such than the phase shifts applied to the laser beam 51 would be fewer and/or more gently varying. This, in turn, would allow a total control of the beam divergence and also the speckle grain characteristics. Moreover, speckle grain size can be controlled by additional SLM 50 aperture apodization.

Control of the beam divergence improves power coupling and control of the speckle grain size are beneficial for deeper imaging. Indeed, although, relatively larger speckle grains 23 would reduce resolution, the depth of penetration should improve. Speckle grains 23, even when large, still exhibit unity contrast.

In addition to allowing control over speckle grain size, the SLM 50 can be used to control the acquisition time by controlling the manner in which the speckles are rendered “dynamic”. With a moving diffuser plate 13, change in the speckle pattern is provoked in a completely random fashion at each pattern update. With a SLM 50, on the other hand, one can program updates in the speckle pattern that are not necessarily “random”. In principle, this leads to strategies for much more rapid sample coverage, such as about one (1) second versus about one (1) minute, and better sectioning capability. Hence, faster convergence to acceptable DSI image quality is possible using a SLM 50 for dynamic speckle illumination.

### Optical (Depth) Sectioning

Having described a DSI microscope 10 in accordance with the present invention, the use of same to provide optical (depth) sectioning is now described. Optical (depth) sectioning makes multi-dimensional imaging on relatively thick objects 19 possible. Typically, optical (depth) sectioning in a fluorescent sample 19 is performed by acquiring a sequence of images.

First, a sequence of images is recorded. More specifically, each image of the sequence of images corresponds to a different dynamic speckle pattern. When using a diffuser plate 13, each image is obtained from a different position of the diffuser plate 13. Before each acquisition, the diffuser plate 13 is rotated by one “step” in order to randomize the speckle pattern.

In the focal plane 22, the detection point spread function PSF_{det} has the same or substantially the same size as the speckle grains. Accordingly, the intensity of the in-focus light incident on each CCD pixel of the imaging device 17 varies between a maximum (obtained when a speckle grain entirely overlaps with the PSF_{det}) and a minimum of zero (obtained when no speckle grain, is overlapping with the PSF_{det}). Thus, the contribution of the in-focus light to the variance is very important.

In the other, non-focal planes, by contrast, the detection point spread function PSF_{det} is larger in size than the speckle grains. As a result, the out-of-focus light intensity can be averaged over several speckle grains to exhibit a smaller variance.

By changing the illumination pattern, either by small lateral shifts in the grid, or by random displacements in the speckle grains, the in-focus, highly-contrasted signal will “appear” to change more than the out-of-focus, poorly-contrasted background. An algorithm that preferentially extracts these apparent changes therefore confers depth sectioning. A DSI indicator, such as the one described below, does exactly this: signals that vary little from image to image contribute weakly to the final DSI image, whereas signals that vary a lot from image to image contribute strongly to the final DSI image.

For example, the final DSI image can be obtained by calculating the RMS of the entire image sequence; that is, the intensity value of each pixel in the final DSI image is provided by the RMS of the corresponding pixel values in the image sequence. The RMS algorithm is one of many possible algorithms that can extract varying components in an image sequence, while suppressing components that do not significantly vary.

In practice, the number of raw images, N, in the image sequence must be finite. Hence, the calculated RMS is merely an estimate of the true RMS where N approaches infinity. The DSI technique uses an indicator to estimate RMS as is done with the SLI technique. More particularly, a DSI indicator, DSI=\sqrt{Σ(Iₙ₊₁−Iₙ)²/2N}, compares each image with the preceding image only, whereas the usual SLI indicator, SLI=\sqrt{(ΣIₙ²)/N−(ΣIₙ)²/N²}, compares each image with N−1 other images in the sequence.

As a result, the DSI indicator described above is more robust than the SLI indicator since it is insensitive to artifactual, long-term intensity fluctuations that can be caused by laser drifts and/or by coarse diffuser non-homogeneities. The SLI indicator is not unusable for DSI applications, and, moreover, only usable, in general application, for small numbers of sequence images, N, such as N=3.

To estimate optical sectioning strength, the expected intensity variance at each pixel for any infinitely-thin, uniformly-fluorescent plane can be calculated as a function of the defocus position z_{c} of the fluorescent plane. Speckle intensity in the sample can be defined as Iₛ(\vec{p},z), and the fluorophore concentration for the plane can be defined as C(\vec{p}.z)=Cδ(z−z_{c}).

Normalizing the detection and illumination point spread functions (denoted PSF_{det} and PSFᵢₗₗ, respectively) such that PSF(0,0)=1 and ∫PSF(\vec{p},z)d²\vec{p}=A, the intensity at the detector plane can be expressed by:

I_{d}(\vec{ρ}_{d})=∫∫PSF_{det}(\vec{ρ}_{d}−\vec{ρ},−z)C(\vec{ρ},z)Iₛ(\vec{ρ},z)d²\vec{ρ}dz [1]

where, for simplification, one can assume unit magnification between the image plane and object plane 22.

Signal variance is defined by V(\vec{p}_{d})= [symbol] I_{d}(\vec{p}_{d})² [symbol] − [symbol] I_{d}(\vec{p}_{d}) [symbol] ², where the angular brackets represent intensity averaging over independent speckle patterns. With wide-field Koehler illumination, the speckle average intensity is roughly independent on the position inside the sample, which is to say [symbol] Iₛ(\vec{p},z) [symbol] = [symbol] Iₛ [symbol] .

Therefore, the equation [1] simplifies to

[symbol]

I_{d}(\vec{p}_{d}) [symbol] =CA [symbol] Iₛ [symbol] . [2]

To calculate [symbol] I_{d}(\vec{p}_{d})² [symbol] , a first-order statistics of the speckle pattern can be used. Assuming that the speckle size is roughly constant over a large depth of field, the first-order correlation of the speckle pattern can be expressed by

[symbol]

Iₛ(\vec{ρ},z)Iₛ(\vec{ρ}′,z) [symbol] = [symbol] Iₛ [symbol] ²{1+PSFᵢₗₗ(Δρ,0)} [3]

where Δp=|\vec{p}−\vec{p}′). Introducing the correlation function:

R_{det}(Δ\vec{p},z_{c})=∫PSF_{det}(\vec{p}_{d}−\vec{p},−z_{c})

PSF_{det}(\vec{p}_{d}−\vec{p}+Δ\vec{p},−z_{c})d²\vec{p} [4]

where ∫R_{det}(Δ\vec{p},z_{c})d²Δ\vec{p}=A²), the variance can then be expressed by:

V(\vec{p}_{d})=(Iₛ)²C²∫R_{det}(Δ\vec{p},z_{c})PSFᵢₗₗ(Δρ,0)d²Δ\vec{ρ} [5]

To obtain a more precise idea of the expected sectioning capacity, one can take the example of a Gaussian-Lorentzian PSF:

$${PSF}_{det} ( \vec{p} , z ) = \frac{1}{1 + {ζ}^{2}} {e}^{- 2 {p}^{2} / {w}_{0}^{2} ( 1 + {ζ}^{2} )} \\ where \\ ζ = \frac{λz}{π {w}_{0}^{2}} . \qquad [ 6 ]$$

With this definition, A=πw₀²/2, and

$${R}_{det} ( Δ \vec{p} , {z}_{c} ) = \frac{π {w}_{0}^{2}}{4 ( 1 + {ζ}_{c}^{2} )} {e}^{- Δ {p}^{2} / {w}_{0}^{2} ( 1 + {ζ}_{c}^{2} )} \qquad [ 7 ]$$

Thus, the RMS at each pixel is found to be equal to

$$RMS = \frac{〈 {I}_{s} 〉 CA}{\sqrt{3 + 2 {ζ}_{c}^{2}}} . \qquad [ 8 ]$$

In short, RMS for DSI microscopy is proportional to 1/|Zc| where |Zc| is larger than the Rayleigh length z_{R}=πw₀²/λ, confirming that depth discrimination can be provided.

The same calculation leads to a signal proportional to 1/(Zc)² for a confocal microscope and to a constant signal for a wide-field microscope, which does not provide depth sectioning. Thus, the DSI technique confers “quasi-confocal” sectioning because the signal is proportional somewhere between zero (corresponding to wide-field microscopy) and 1/(Zc)² (corresponding to confocal microscopy).

In summary, for each DSI image, if there are a whole number, N, of raw images of intensity Iₙ and each image corresponds to a different speckle pattern, a possible DSI indicator can be calculated using the formula: \sqrt{Σ(Iₙ₊₁−Iₙ)²/2N}. This indicator is preferentially used instead of the more common SLI indicator formula: \sqrt{(ΣIₙ²)/N−(ΣIₙ)²/N²}, because it is insensitive to artifactual, low-frequency intensity fluctuations that are caused by the light source (laser) 12 or by the diffuser plate 13. Indeed, the DSI indicator formula compares each image with the images acquired immediately before and after, whereas the SLI indicator compares each image with N−1 other images.

Axial resolution of the final DSI image with the RMS algorithm can be defined by the full-width-half-maximum (FWHM) of the RMS signal, which is approximately equal to 3 λ/NA². This resolution is comparable, i.e., of the same order of magnitude, with the confocal microscope axial resolution, namely 1.4λ/NA². However, the contribution from out-of-focus light to the image will be larger than with a conventional confocal microscope because the RMS signal decreases more slowly with z_{c}.

The results cited above apply to DSI imaging using an RMS algorithm to extract variations in the raw image sequence. DSI microscopy, however, is not restricted to the RMS algorithm alone, but can work with any algorithm that extracts variations in the raw image sequence.

### Results

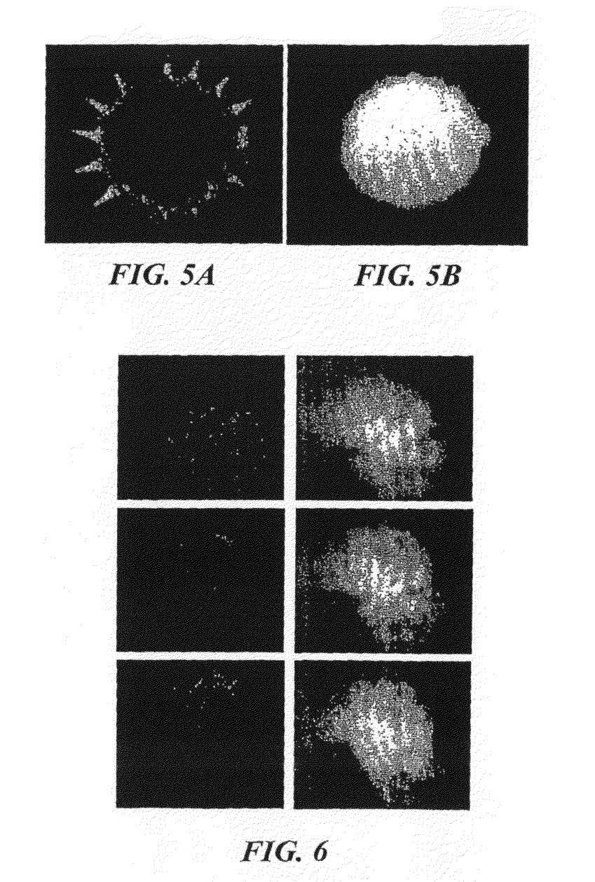

Fluorescence imaging using dynamic speckle illumination (DSI) with an RMS algorithm and using wide-field imaging are presented in FIGS. 5A and 5B, respectively. FIG. 5A shows an image of a pollen grain obtained by computing an RMS over 128 raw images. The exposure time for each raw image is about 150 ms. The conventional wide-field image (FIG. 5B) is recovered simply by averaging the raw images. On the RMS image (FIG. 5A), the center of the pollen grain appears much darker than the spines whereas it is just the opposite on the conventional image (FIG. 5B).

Referring to FIG. 6, a comparison of a wide-field images (on the right) and DSI images (on the left) for increasing tissue thicknesses (10 microns, 20 microns, and 30 microns from top to bottom) can be seen. The images are of a mouse olfactory bulb glomerulus. For each DSI image, the RMS has been calculated over 64 raw images, with an exposure time of about one (1) second per raw image.

Comparison with regular, wide-field images demonstrates that DSI microscopy rejects most of the out-of-focus blurred light that wide-field imaging cannot. The glomerulus can be viewed with better lateral resolution with DSI microscopy. Moreover, good image quality through a depth of about 80 microns was achieved.

DSI microscopy provides several advantages over SLI microscopy, especially when imaging in relatively “thick” tissue. For example, although, microscopy by SLI or DSI relies on high signal contrast from the in-focus object plane, if the in-focus plane produces low signal contrast, then the capacity for depth sectioning is lost. Additionally, with relatively “thick” biological tissue samples, which are highly scattering, the tissue sample imparts spatially random phase variations onto any incoming illumination front. With SLI, the phase profile of the illumination front must remain very well-defined to produce a highly-contrasted grid pattern at the in-focus object plane. The more wideband the SLI wavelength spectrum, the more tightly defined the phase profile must be. This is true for all wavelength components. Indeed, this is why high-resolution SLI microscope objectives must be chromatically corrected. As a result, with SLI, any scrambling of the phases provoked by relatively “thick” tissue inevitably leads to a rapid degradation in the contrast of the grid pattern and, hence, to a degradation in sectioning capacity.

The situation is very different in the case of illumination by DSI. Speckle arises from an illumination front whose phase profile is already random. Hence, any additional randomness imparted by the tissue only re-adjusts the exact locations of the peaks and valleys in the illumination intensity. Randomness does not change the fundamental nature of the speckle. That is, the speckle grains remain highly contrasted even in relatively “thick” tissue.

During the image detection stage, recalling that fluorescence is incoherent, with SLI, optical (depth) sectioning is already hampered because there is little difference in contrast between the in-focus and out-of-focus planes to start with. On the other hand, with DSI, out-of-focus light will be blurred relative to the in-focus light upon imaging, rendering sectioning possible. Thus, now, in addition, the target object 19 will impart its own additional blurring to both the in-focus and out-of-focus components. This additional blurring will degrade the sectioning capacity of a DSI microscope to some degree. Nevertheless, as long as the detected in-focus contrast remains greater than the detected out-of-focus contrast, optical sectioning remains possible.

The severity of incoherent signal blurring is different for different length scales. Although blurring completely washes out the fine structures of a fluorescence image, it has much less effect on the coarse structures. Hence, the more one is willing to sacrifice image resolution, the more immune DSI imaging will be to scattering and, moreover, the greater the depths it will attain.

DSI microscopy, however, has a few shortcomings in comparison with SLI microscopy. First, SLI microscopy, as a rule, requires relatively few image acquisitions and, therefore, can be faster and may require less memory storage for image data. Indeed, in many applications, by shifting a grid pattern a maximum of three times, full, uniform coverage of the object plane is achievable.

In contrast, random displacement of the speckle grains does not guaranty full, uniform coverage of the object plane. Therefore, three image sequences are usually not sufficient to produce a final DSI image of acceptable quality. Consequently, DSI microscopy is, in general, slower than SLI microscopy.

Any residual non-uniformity in the image coverage scales as 1/N, where N is the number of raw images. Accordingly, the larger the number of acquired images the more uniform the coverage. However, too many acquired images provides diminishing returns. In practice, the inventors have found that about 50 images are required to obtain micron resolution images of good quality.

SLI microscopy also may have an intrinsically stronger depth sectioning capacity at shallower depths than DSI microscopy. This is true because out-of-focus contrast reduction is stronger with SLI, which undergoes a two-fold blurring (during both the illumination and the detection stages), than with DSI, which undergoes blurring only during the detection stage.

As imaging depth is increased, however, phase variations provoked by the target object 19 become more and more significant and the grid pattern can no longer reliably be delivered to the focal plane 22. If the illumination is incoherent, then the pattern contrast disappears and depth sectioning becomes impossible.

However, if the illumination is coherent, then the contrast does not disappear at all. Instead, illumination becomes “speckle”. Hence, by using coherent illumination, a continuous transition from SLI to DSI imaging modalities can be attained. Furthermore, by creating a grid pattern with a coherent laser source, if the target object 19 does not provoke significant phase perturbations provoked by excessive depth, then the grid pattern is reliably delivered to the focal plane 22 inside the target object 19. Full coverage of the target object 19 is then readily obtained by shifting the pattern only three times, and a DSI algorithm such as the RMS algorithm applied to these three images provides depth sectioning.

Thus, according to another aspect of the present invention, DSI and SLI microscopy components can be readily combined in a single instrument to combine the advantages of both techniques, to maintain sectioning capacity deep in tissue with DSI and to obtain sectioning with fewer images near the surface with SLI.

For example, at relatively shallow imaging depths, SLI sectioning is achievable and as few as three images (N=3) are required. As imaging depth increases, more images are required and the sectioning is produced by DSI. The sectioning algorithm remains the same for both cases, however (for example, the RMS algorithm). Optionally, a feedback mechanism and control system can automatically adjust the number of images according to depth.

As mentioned above, a SLM 50 allows the possibility of controlling not only pixel phase but also pixel amplitude. Thus, with a SLM 50, not only can speckle patterns be produced, but also, well-defined geometric patterns can be produced. In particular, a shifting grid pattern similar to the one used in SLI microscopy can be provided. Accordingly, by using a SLM 50 in combination with an incoherent light source 12, the SLI/DSI hybrid microscope would effectively be a SLI microscope.

A DSI “macroscope” is also disclosed. A current industry trend has been towards development of “macroscopes”, which, at the expense of resolution and light collection efficiency, provide relatively long working distances, i.e., a few tens of centimeters, to allow room for surgical applications.

Disclosure up to this point has centered around DSI imaging that is microscopic, i.e., resolution measured in sub-microns or microns. However, DSI molecular imaging can also be scaled up beyond the micron range. Resolution of DSI imaging is governed by the numerical apertures (NA) of both the illumination optics and of the detection optics. In particular, illumination NA governs speckle size, mostly responsible for axial resolution, whereas the detection optics mostly govern lateral resolution.

In contrast to microscopes, macroscopes are imaging devices that have relatively long working distances (typically measured in tens of centimeters) and low NA's. Long working distances are indispensable for surgical applications. Low NA's allow relatively deep imaging but at the expense of resolution. A DSI macroscope should produce similar images as already obtained by commercial instruments, except without the out-of-focus haze.

In practice, the construction of a DSI macroscope entails the replacement of the (Microscope) objective 18 with a “macro” objective lens, and the concomitant adjustment to the light source expansion and detection optics.

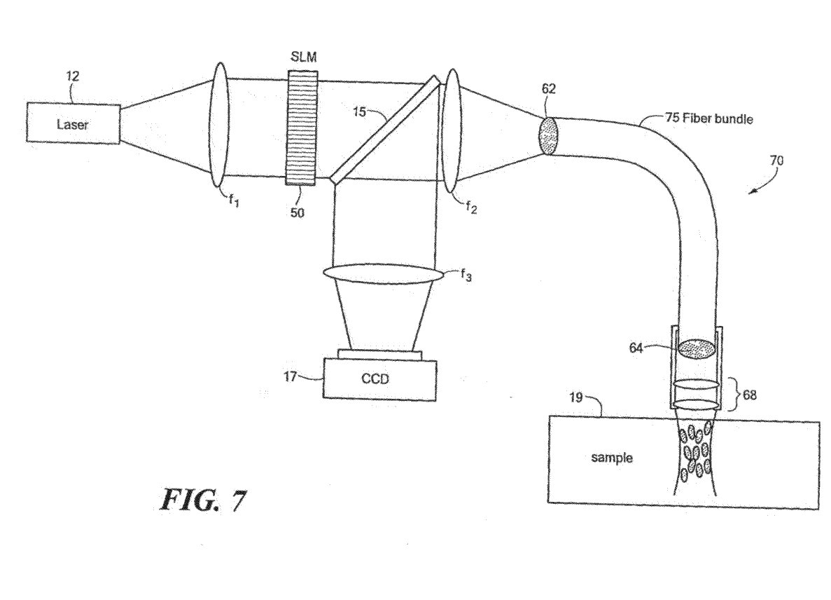

A “fiberscope” version of the DSI microscope is also disclosed for use as a surface probe, or as an endoscope. FIG. 7 shows a design of a simple fiberscope 70. An imaging optical-fiber bundle 75 is included to deliver DSI and also to relay the fluorescence image signals back to the remote, CCD camera 17. An imaging optical-fiber bundle 75 consists of a bundle of multimode, optical fibers that are packed or packaged in such a way that an intensity pattern (as opposed to a field pattern) incident on a first, proximal end 62 of the bundle 75 is relayed to a second, distal end 64 of the bundle 75 without being spatially scrambled or diffused.

Optical-fiber bundles 75 are readily available in commerce. For example, optical-fiber bundles 75 having 30,000 fibers (effectively corresponding to 30,000 image pixels) and a diameter of only about 0.5 mm are commercially available and suitable for DSI microscopy use. Each fiber core diameter is about 4 μm and the core-to-cladding area ratio is about 0.9.

In operation, speckle illumination controlled by a SLM 50 is channeled into a target object 19 via an imaging fiber bundle 75. The incoherent, fluorescence image of the target object 19 is channeled back to a CCD camera 17 via the same bundle 75 and a dichroic mirror 15. Thus, laser illumination is delivered into the target object 19 via the fiber bundle 75 using all available fibers and a lens 68.

Fluorescence produced inside the target object 19 is then imaged onto the fiber bundle 75, again using all available fibers, via this same lens 18, and then re-imaged onto a CCD camera 17 via a second lens f3. Such a configuration is similar to the commercially available “CellVizio” confocal endoscope manufactured by Mauna Kea Technologies, Inc. of Cambridge, Mass.

When making use of an optical-fiber bundle 75, it is important to recognize the distinction between incoherent light transmission through the bundle 75 and coherent light transmission through a bundle 75. In general, the phase of each light ray going through each fiber is not well-defined. Normally, spatial phase randomization provokes a blurring of an intensity pattern because it randomly alters the directions of the constituent light rays.

However in the case of a fiber bundle, the directions of the constituent rays are preserved because they are physically guided through the fibers. Hence an input intensity pattern is preserved from the first, proximal end 62 of the fiber bundle to the second, distal end 64, even though the input phase pattern is not preserved.

Because incoherent fluorescence imaging involves the transmission of an intensity pattern only, it can readily be performed via a fiber bundle 75. Random phase shifts incurred by the coherent illumination, however, will unavoidably manifest themselves downstream from the bundle 75 as speckle. This speckle “problem” is well known by endoscopists and is one of the main reasons why, conventionally, coherent laser illumination is not used with imaging fiber bundles 75.

However, whereas speckle is usually regarded as a “problem” in most imaging applications using optical-fiber bundles 75, with DSI microscopy, use of a fiber bundle 75 readily allows both generation of coherent speckle and image incoherent fluorescence, which are core principles of DSI microscopy.

To render the speckle pattern in a bundle 75 “dynamic”, various alternatives can be employed. For example, a SLM 50 can be used at the bundle input. Alternatively, the bundle 75 itself can be mechanically jiggled, for example, using a piezoelectric transducer. In both cases, the speckle pattern can be randomly changed before each new raw-image acquisition.

The frequency of operator-induced motion should be slow enough that the speckle will not vary significantly during acquisition of each new raw-image. Accordingly, image acquisition time should be reduced by increasing the signal frequency.

It will be apparent to those of ordinary skill in the art that modifications to and variations of the above-described system and method may be made without departing from the inventive concepts described herein. Accordingly, the invention should not be limited except by the scope and spirit of the appended claims.

What is claimed is:

1. A microscope for performing three-dimensional fluorescence imaging with out-of-focus background rejection, the microscope comprising:
at least one light source for producing light to illuminate a target object in an object plane;
an image recording device for detecting and imaging a sequence of images of the target object;
imaging optics for transmitting illumination light from the at least one light source into the target object and for transmitting fluorescence signals, such as said sequence of images, from said target object to the image recording device; and
a dynamic speckle generating system for illuminating the target object with dynamic speckle.

2. The microscope as recited in claim 1, wherein the at least one light source provides coherent, narrowband wavelength light.

3. The microscope as recited in claim 1, wherein the at least one light source is at least one high-intensity light source selected from the group comprising a laser, an argon gas laser, a near-infrared (NIR) laser, a helium-neon laser, and multiple excitation sources providing light having different wavelengths.

4. The microscope as recited in claim 3, wherein the NIR laser operates in a wavelength range between about 700 nm and about 1 μm.

5. The microscope as recited in claim 1, wherein the imaging optics include a plurality of beam focusing or expansion lenses, an objective for focusing light incident on its back aperture onto the object plane of the target object; and a dichroic beam-splitter for collecting fluorescence light from the target object.

6. The microscope as recited in claim 1, wherein the dynamic speckle generating system comprises a liquid-crystal spatial light modulator having an array of pixels.

7. The microscope as recited in claim 6, wherein random or non-random phase shifts can be applied to each pixel in the array of pixels of the liquid-crystal spatial light modulator to provide a dynamic speckle pattern.

8. The microscope as recited in claim 6, wherein illumination amplification changes can be applied to each pixel in the array of pixels of the liquid-crystal spatial light modulator to provide an amplitude pattern, such as a grid pattern.

9. The microscope as recited in claim 1, wherein the dynamic speckle generating system comprises a moving diffusing device to produce dynamic speckle illumination.

10. The microscope as recited in claim 1, wherein a stepper motor rotates the diffuser device one step per image to provide a plurality of images.

11. The microscope as recited in claim 1, wherein the image recording device is a digital CCD camera.

12. The microscope as recited in claim 1, wherein the image recording device is capable of multi-color imaging.

13. The microscope as recited in claim 12, wherein the image recording device is capable of multi-color imaging using either a single image recording device and a plurality of emission filters or using plural image recording devices and dichroics.

14. The microscope as recited in claim 1, wherein the target object is relatively thick, having a thickness of about 100 microns.

15. The microscope as recited in claim 1, wherein the microscope further includes a feedback mechanism and control system to control the number of images detected and imaged from the sequence of images as a function of depth into the target object.

16. The microscope as recited in claim 15, wherein the at least one light source is a coherent light source and the dynamic speckle generating system is a liquid-crystal spatial light modulator, and wherein the control system provides SLI imaging and takes fewer images at relatively shallow depths and provides DSI imaging and takes more images at increasingly deeper depths.

17. The microscope as recited in claim 1, wherein the at least one light source includes a coherent light source in combination with an incoherent light source for comparing image quality produced by each light source at various depths of the target object.

18. The microscope as recited in claim 1, wherein the microscope includes a bundle of optic-fibers for transmitting light to the target object and for transmitting fluorescence image signals to the image recording device.

19. A method of fluorescence imaging with out-of-focus background rejection, the method comprising:
illuminating a target object with dynamic speckle illumination;
detecting an image sequence of plural images from the target object resulting from the dynamic speckle illumination;
estimating an RMS of each image of the image sequence; and
imaging a final DSI image exhibiting out-of-focus background rejection.

20. The method as recited in claim 19, wherein each image of the sequence of plural images corresponds to a unique speckle pattern.

21. The method as recited in claim 19, wherein the final DSI image is obtained by calculating the RMS of the image sequence using an intensity value of each pixel in the final DSI image.

22. The method as recited in claim 21, wherein the RMS of each image of the sequence of plural images is estimated by comparing an image of each pixel only with a preceding image of the same pixel.

23. The method as recited in claim 19, wherein the target object is illuminated using an incoherent, narrowband wavelength light.

24. The method as recited in claim 19, wherein dynamic speckle is generated using a moving diffuser plate that is periodically rotated by one step before acquiring a next image in the sequence of plural images.

25. The method as recited in claim 19, wherein dynamic speckle is generated using a liquid crystal spatial-light modulator.

26. The method as recited in claim 19, wherein the RMS of each image of the sequence of plural images is estimated using the equation:
RMS=\sqrt{Σ(Iₙ₊₁−Iₙ)²/2N}
where N is the number of images in the sequence of plural images, Iₙ is an intensity of a pixel for image n in the sequence of plural images and Iₙ₊₁ is an intensity of the pixel for image n+1 in the sequence of plural images.

27. A method of fluorescence imaging with out-of-focus background rejection, the method comprising:
illuminating a target object with dynamic speckle illumination;
detecting an image sequence of plural images from the target object resulting from the dynamic speckle illumination;
numerically extracting varying components in the image sequence of plural images; and
generating a final DSI image exhibiting out-of-focus background rejection.

28. The method as recited in claim 27, wherein each image of the sequence of plural images corresponds to a unique speckle pattern.

29. The method as recited in claim 27, wherein the final DSI image is obtained by numerical processing based on the intensity value of each pixel of the image.

30. The method as recited in claim 27, wherein the target object is illuminated using an incoherent, narrowband wavelength light.

31. The method as recited in claim 27, wherein dynamic speckle is generated using a moving diffuser plate that is periodically rotated by one step before acquiring a next image in the sequence of plural images.

32. The method as recited in claim 27, wherein dynamic speckle is generated using a liquid crystal spatial-light modulator.
